(19) United States
(12) Patent Application Publication
(10) Pub. No.: US 2014/0282172 A1
(43) Pub. Date: Sep. 18, 2014

(54) SYSTEM AND METHOD FOR GRAPHICALLY DISPLAYING ENERGY CONSUMPTION AND SAVINGS

(71) Applicant: LUTRON ELECTRONICS, CO., INC., Coopersburg, PA (US)

(72) Inventors: John H. Bull, Coplay, PA (US); Timothy S. Majewski, New Tripoli, PA (US)

(73) Assignee: LUTRON ELECTRONICS, CO., INC., Coopersburg, PA (US)

(21) Appl. No.: 13/826,947

(22) Filed: Mar. 14, 2013

(51) Int. Cl. G06F 3/0484

(52) U.S. Cl. CPC G06F 3/0484
USPC 715/771

(57) ABSTRACT

A system for displaying the consumption of electrical energy by an electrical energy consumer in a graphical format. An amount of electrical energy saved is the difference between a reference amount of the electrical energy capable of being consumed by the consumer and an actual amount of the electrical energy consumed by the consumer, wherein the reference amount is determined either from a peak amount of power consumed during a preset window of time during which the consumer utilizes electrical energy, or by an average amount of power consumed during the preset time window. A visual display provides an electronic representation of the amount of the electrical energy consumed and the amount of the electrical energy saved in a graphical format.

### CROSS-REFERENCE TO RELATED APPLICATIONS

This application is related to U.S. patent application Ser. No. 12/044,672, filed Mar. 7, 2008 by Ian Rowbottom et al. entitled SYSTEM AND METHOD FOR GRAPHICALLY DISPLAYING ENERGY CONSUMPTION AND SAVINGS, the entire disclosure of which is hereby incorporated by reference.

### BACKGROUND OF THE INVENTION

1. Field of the Invention

The present invention relates generally to graphical displays, and, more particularly, to graphically displaying energy consumption and savings at selected locations.

2. Description of the Related Art

Increasingly, awareness of the consumption of energy and resources is prevalent in mainstream society and politics. The so-called “green” movement is no longer considered on the fringe or outside of mainstream society, as concerns of global warming and other deleterious planetary conditions resulting from excessive energy and resource consumption are on the rise. Further, as global communications converge with everyday and common activities and devices, the desire for information of all kinds similarly increases, such as, for example, the desire for information representing energy consumption. As awareness and concerns about environmental resource consumption and waste increase, particularly as it affects global warming, people and organizations are increasingly looking for information that represents the extent to which a particular building or structure or energy consuming function is energy efficient. Tenants of an office building, or local government agencies, for example, would like to know whether the building is energy efficient and effective to cut back harmful emissions that might contribute to global warming or to increased energy costs.

Fuel and energy consumption occurs indoors from various sources. For example, electrical power is consumed in lighting, heating and air conditioning (“HVAC”), and in various devices that are plugged into electrical outlets (e.g., 120 V or 240 V wall-mounted electrical outlets). Also, hardwired equipment in a building consumes electricity.

Typical load control systems are operable to control the amount of power delivered to an electrical load, such as a lighting load or a motor load, from an alternating-current (AC) power source. A load control system generally comprises a plurality of control devices coupled to a communication link to allow for communication between the control devices. The control devices of a lighting control system include load control devices operable to control the amount of power delivered to the loads in response to digital messages received via the communication link or local inputs, such as user actuations of a button. Further, the control devices of a lighting control system often include one or more keypad controllers that transmit commands via the communication link in order to control the loads coupled to the load control devices.

Information regarding the electrical power consumption and the pattern of the consumption in an electrical system is known to be collected and stored. Often, a building manager of a building (in which such an electrical system is installed) can visually monitor the total power being consumed by the electrical system. However, other users and visitors of the building are not able to view this information. Therefore, there is a need for convenient and informative display of information that represents responsible environmental and fiscal management with respect to resource consumption and savings.

In commonly assigned U.S. application Ser. No. 12/044,672, described above, a system for displaying energy savings is described. In that system, a reference value for determining the energy savings is used that comprises the maximum energy usage of all the energy consuming devices, that is, when all energy consuming devices are turned on and at their maximum levels. For example, in a lighting system, it is assumed all lamps are turned on all the time and at their maximum brightness. The energy consumed based on this maximum usage is used as the reference level to determine the savings, which is calculated as the difference between the maximum usage level and the estimated level of usage based on such factors as whether the energy consuming devices in the system are turned on or off and their level of energy usage (in the case of lighting, energy usage can be determined by the dimming level of lamps). The information concerning consumption by the devices is then used to estimate the total energy usage of the system. From this, the savings are calculated by subtracting this estimated usage from the maximum usage.

This method of determining usage and thus savings is useful, but it may, for example, overestimate savings, in the case where using such a maximum energy level as the reference is unrealistic. For example, it may be unrealistic because lamps in a lighting system of a building are never all turned on at maximum brightness today, particularly because devices like occupancy sensors, dimmers and daylighting systems (systems that automatically control window treatments to bring in ambient daylight) are in widespread use.

Accordingly, it is desirable to provide a system that can be used to provide a more realistic estimate of energy usage and savings. Furthermore, it is desirable to provide such a system that can incorporate actual usage information from electrical energy usage meters, and particularly smart energy usage meters.

### SUMMARY OF THE INVENTION

According to an embodiment of the present invention, a system is provided for displaying an electronic representation of the consumption of electrical energy by an electrical energy consumer in a graphical format, the system comprising an information processor coupled to a communication network, a database accessible by the information processor that stores information including a reference amount of the electrical energy capable of being consumed by the consumer; and the actual amount of the electrical energy consumed by the consumer; the reference amount being obtained from an electrical power usage meter through which electrical energy is supplied to the consumer; the information processor operable to determine an amount of electrical energy saved as the difference between the reference amount of the electrical energy capable of being consumed by the consumer and the actual amount of the electrical energy consumed by the consumer; wherein the reference amount is determined from a peak amount of power consumed by the consumer during a preset window of time during which the consumer utilizes electrical energy or by an average amount of power consumed by the consumer during the preset window of time; and a visual display operable by the information processor, the visual display providing an electronic representation of the amount of the electrical energy consumed by the consumer and the amount of the electrical energy saved, wherein the visual display presents the electronic representation in a graphical format.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 is a simplified block diagram of a lighting control system 100 according to an aspect of the present invention;

FIG. 2A shows an example of a hardware arrangement of an embodiment of the present invention;

FIG. 2B is a block diagram illustrating functional elements of an information processor of the hardware arrangement of FIG. 2A;

FIG. 3 is a block diagram illustrating data elements that may be stored in a database and provided in connection with graphical displays;

FIG. 4 shows a block diagram illustrating modules that interact to provide graphical screen displays that represent energy and resource consumption and savings;

FIGS. 5A-5H are examples of display screens that are provided to users in accordance with a first embodiment of the present invention;

FIG. 6 is a simplified flowchart of a configuration procedure;

FIG. 7 is a simplified flowchart of a display procedure;

FIG. 8 is a simplified flowchart of an input procedure;

FIG. 9A illustrates an example resource consumption and savings graphical gauge that is displayed in accordance with a second embodiment of the present invention;

FIG. 9B illustrates an example energy resource consumption and savings graphical gauge when the energy consumption has exceeded the maximum rated output of the facility;

FIGS. 10A-10D are examples of display screens that are provided to users in accordance with the second embodiment;

FIG. 11 represents another example display screen with additional functional controls that is provided to users in accordance with a third embodiment of the present invention; and

FIG. 12 shows an example power usage graph.

### DETAILED DESCRIPTION OF EMBODIMENTS OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

FIG. 1 is a simplified block diagram of a lighting control system 100, which can be monitored according to an embodiment of the present invention. The lighting control system 100 is operable to control the level of illumination in a space by controlling the intensity levels of the electrical lights in the space and the positions of the window treatments in the space. As shown in FIG. 1, the lighting control system 100 is operable to control the amount of power delivered to (and thus the intensity of) a plurality of lighting loads, e.g., a plurality of fluorescent lamps 102. The lighting control system 100 is further operable to control the position of a plurality of motorized window treatments, e.g., motorized roller shades 104, to control the amount of daylight entering the space.

Each of the fluorescent lamps 102 is coupled to one of a plurality of digital electronic dimming ballasts 110 for control of the intensities of the lamps. The ballasts 110 are operable to communicate with each other via digital ballast communication links 112, e.g., digital addressable lighting interface (DALI) communication links. The digital ballast communication links 112 are also coupled to digital ballast controllers (DBCs) 114, which provide the necessary direct-current (DC) voltage to power the communication links 112, as well as assisting in the programming of the lighting control system 100. Each of the ballasts 110 is operable to receive inputs from a plurality of sources, for example, an occupancy sensor (not shown), a daylight sensor (not shown), an infrared (IR) receiver 116, and a wallstation 118. The ballasts 110 are operable to transmit digital messages to the other ballasts 110 in response to the inputs received from the various sources. For example, up to 64 ballasts 110 are operable to be coupled to a single digital ballast communication link 112.

The ballasts 110 may receive IR signals 120 from a handheld remote control 122, such as, e.g., a personal digital assistant (PDA), via the IR receiver 116. The remote control 122 is operable to configure the ballast 110 by transmitting configuration information to the ballasts via the IR signals 120. Accordingly, a user of the remote control 122 is operable to configure the operation of the ballasts 110. For example, the user may group a plurality of ballasts into a single group, which may be responsive to a command from the occupancy sensor. The programming information is stored in memory of each of the ballasts 110.

Continuing with reference to FIG. 1, each of the motorized roller shades 104 comprises an electronic drive unit (EDU) 130. Each electronic drive unit 130 is located inside the roller tube of the associated roller shade 104. The electronic drive units 130 are responsive to digital messages received from a wallstation 134 via a shade communication link 132. The user can open or close the motorized roller shades 104, adjust the position of the shade fabric of the roller shades, or set the roller shades to preset shade positions using the wallstation 134. The user can configure the operation of the motorized roller shades 104 using the wallstation 134. For example, up to 96 electronic drive units 130 and wallstations 134 are operable to be coupled to the shade communication link 132. A shade controller (SC) 136 is coupled to the shade communication link 132 and is operable to build a shade database.

A plurality of processors 140 allow for communication between a workstation 150, i.e., a personal computer (PC), and the load control devices, i.e., the ballasts 110 and the electronic drive units 130. Each processor 140 is operable to be coupled to one of the digital ballast controllers 114, which is coupled to the ballasts 110 on one of the digital ballast communication links 112. Each processor 140 is further operable to be coupled to the shade controller 136, which is coupled to the electronic drive units 130 of the motorized roller shades 104 on one of the shade communication links 132. The processors 140 and the workstation 150 are coupled to an inter-processor link 152, e.g., an Ethernet link, such that the workstation 150 is operable to transmit digital messages to the processors 140 via a standard Ethernet switch 154. An example of a communication protocol for the inter-processor link 152 is described in greater detail in U.S. patent application Ser. No. 11/938,039, filed Nov. 9, 2007, entitled INTERPROCESSOR COMMUNICATION LINK FOR A LOAD CONTROL SYSTEM, the entire disclosure of which is hereby incorporated by reference.

The workstation 150 executes a graphical user interface (GUI) software, which is displayed on a screen 156 of the workstation. The GUI allows the user to configure and monitor the operation of the lighting control system 100. During configuration of the lighting control system 100, the user is operable to determine how many ballasts 110, digital ballast controllers 114, electronic drive units 130, shade controllers 136, and processors 140 that are connected and active using the GUI software. Further, the user may also assign one or more of the ballasts 110 to a zone or a group, such that the ballasts 110 in the group respond together to, for example, an actuation of the wallstation 118. The workstation 150 is operable to determine the power consumption of each of the ballasts 110 in the lighting control system 100 by summing the power consumption values to determine a total power consumption of the lighting control system 100. The workstation 150 is operable to display the total power consumption of the lighting control system 100 on the screen 156 of the workstation, and to store the information in one or more databases, as described below.

Further, the workstation 150 is operable to reduce the total power consumption of the lighting control system 100 using a load shedding procedure. The workstation 150 is operable to compare the total power consumption to a load shedding power threshold, which may be set, for example, by a billing threshold of an electrical utility company. If the total power consumption exceeds the threshold, the workstation 150 is operable to cause the ballasts 110 to shed loads, i.e., to dim the lamps to a lower intensity. The lighting control system 100 and the load shedding method is described in greater detail in commonly-assigned co-pending U.S. patent application Ser. No. 11/870,889, filed Oct. 11, 2007, entitled METHOD OF LOAD SHEDDING TO REDUCE THE TOTAL POWER CONSUMPTION OF A LOAD CONTROL SYSTEM, the entire disclosure of which is hereby incorporated by reference.

The workstation 150 dims the lamps in response to the load shedding condition using “tiers”. A tier is defined as a combination of predetermined load shedding amounts for a plurality of electrical loads. For example, “Tier 1” may comprise shedding loads in an office space by 20%, in a hallway space by 40%, and in a lobby by 10%, while “Tier 2” may comprise shedding loads in the office space by 30%, in the hallway space by 50%, and in the lobby by 30%. Each successive tier reduces (or maintains the same) the amount of power being delivered to the electrical loads. Accordingly, the workstation 150 is operable to consecutively step through each of the tiers to continue decreasing the total power consumption of the lighting control system 100 if the total power consumption repeatedly exceeds the load shedding threshold.

FIG. 2A is a simplified diagram of a hardware arrangement for dynamically displaying energy and resource consumption and savings information, which is referred to generally as system 200. The system 200 comprises at least one information processor 162 and at least one workstation 150, each of which is adapted to access communication network 166 and includes at least one database 163. The information processor 162 includes a database 163 and provides an internet web site and user interface for users of workstations 150.

In addition to workstations 150, the system 200 may also include one or more visual displays 168 which may be viewable in public or other settings where a plurality of users can view display screens presented thereon. The visual display 168 may be any suitable display device, such as a television or display monitor, and may be configured in various ways, including a liquid crystal display (“LCD”), a plasma screen display, a rear or forward projection display, CRT, or any other display as known in the art. The visual display 168 may also be formatted in various sizes, and may be suitably sized for viewing by a large number of people. In accordance with an aspect of the present invention, the display 168 is provided in public access areas, such as atriums, lobbies, hallways, or the like, in order to provide various graphical displays of information, as described and shown herein, to viewers.

As noted above, there is a need for convenient and informative display of information that represents responsible environmental and fiscal management with respect to resource consumption and savings. The visual display 168 of the system 200 presents graphical and textual-based information in a dynamic and intuitive format that represents energy and resource consumption and savings, as well as associated contributors to pollution, global warming or the like. Further, the visual display 168 of the system 200 graphically displays information regarding efficient consumption of natural resources, such as light and heat that contribute to resource and energy savings and associated reductions in emissions, green house gases or other contributors to global warming. Moreover, information related to the equipment of a building or another structure, such as the heating, ventilation, and air conditioning (HVAC) equipment, the motorized window treatments, the lighting controls, the utility equipment, the generators, and other power consuming devices, may be provided on the visual display 168.

The visual display 168 of the system 200 allows a user to identify energy and environmental resource information in various areas and contexts of a building or other structure. For example, in case of a multi-story building, the visual display 168 may exhibit various energy consumption and savings in respective floors, rooms and various locations within the building. In addition, information regarding energy resource consumption and savings may be provided over various time periods, such as, for example, twenty-four hours, seven days, one month and one year.

The system 200 further allows for communication with the lighting control system 100 via the Ethernet link 152, and thus the digital ballast communication links 112, the shade communication links 132, and the associated hardware and software elements. Any information that is transmitted or otherwise provided over Ethernet link 152 may be available to the information processor 162, can be stored accordingly on the database 163, and can be dynamically and graphically displayed in accordance with the teachings herein. Even though the information processor 162 is shown including a single database 163 in FIG. 2A, it is contemplated that the information processor 162 can access any required database via the communication network 166 or any other communication network to which the information processor 162 may be coupled. The communication network 166 may be a global public communication network such as the Internet, but can also be a wide area network (WAN), a local area network (LAN), or another network that enables two or more computers to communicate with each other.

The information processor 162 and the workstations 150 may be any devices that are capable of sending and receiving data across the communication network 166, such as, e.g., mainframe computers, mini computers, personal computers, laptop computers, personal digital assistants (PDA) and Internet access devices such as Web TV. In addition, the information processor 162 and the workstations 150 may be equipped with a web browser, such as MICROSOFT INTERNET EXPLORER, NETSCAPE NAVIGATOR, GOOGLE CHROME, MOZILLA FIREFOX and the like. The information processor 162 and the workstations 150 are coupled to the communication network 166 using any known data communication networking technology.

As shown in FIG. 2B, the functional elements of the information processor 162 and/or the workstations 150 are shown, and include one or more central processing units (CPU) 202 used to execute software code and control the operation of the information processor 162, a read-only memory (ROM) 204, and a random access memory (RAM) 206, one or more network interfaces 208 to transmit and receive data to and from other computing devices across the communication network 166, storage devices 210 such as a hard disk drive, solid state drive, a floppy disk drive, a tape drive, a CD ROM drive, or a DVD drive for storing program code databases and application data, one or more input devices 212 such as a keyboard, mouse, track ball, microphone and the like, and a visual display 214. The input devices 212 may further comprise a resistive or capacitive touch screen, which operates in combination with the display 214.

The various components of the information processor 162 need not be physically contained within the same chassis or even located in a single location. For example, the storage device 210 may be located at a site that is remote from the remaining elements of the information processor 162, and may even be connected to the CPU 202 across the communication network 166 via the network interface 208. The information processor 162 includes a memory equipped with sufficient storage to provide the necessary databases, forums, and other community services as well as acting as a web server for communicating hypertext markup language (HTML), Java applets, Active-X control programs or the like to the workstations 150. The information processors 162 are arranged with components, for example, those shown in FIG. 2B, suitable for the expected operating environment of the information processor. The CPU(s) 202, the network interface(s) 208 and the memory and storage devices 210 are selected to ensure that their capacities accommodate the expected demand.

As used herein, the terms “link” and “hyperlink” refer to a selectable connection from one or more words, pictures or other information objects to others in which the selectable connection is presented within the web browser. The information object can include sound and motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of the information processor 162 shown in FIG. 2B are of the same categories of functional elements present in workstations 150. However, not all elements need be present in the workstations 150. For example, storage devices, in the case of PDAs, and the capacities of the various elements are arranged to accommodate the expected user demand. For example, the CPU 202 in the workstation 150 may have a smaller capacity than the CPU present in the information processor 162. Similarly, it is likely that the information processor 162 will include storage devices of a much higher capacity than the storage devices present in the workstation 150. Of course, one of ordinary skill in the art will understand that the capabilities and capacities of the functional elements can be adjusted as needed.

The nature of the invention is such that one skilled in the art of writing computer executable code (i.e., software) can implement the functions described herein using one or more of a combination of popular computer programming languages and development environments including, but not limited to, C, C++, Visual Basic, JAVA, HTML, XML, ACTIVE SERVER PAGES, JAVA server pages, servlets, and a plurality of web site development applications.

Although the present invention is described by way of example herein and in terms of a web-based system using web browsers and a web site server (e.g., the information processor 162), the system 200 is not limited to such a configuration. It is contemplated that the system 200 is arranged such that the workstation 150 communicates with and displays data received from the information processor 162 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on the information processor 162 and the workstations 150, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, WINDOWS 7, WINDOWS 8, MAC OS, IOS, OSX, GOOGLE ANDROID, UNIX, LINUX, PALM OS, POCKET PC and any other suitable operating system. It is contemplated that the workstations can be mobile devices, e.g., smart phones or tablets and that data connections can be wireless.

As used herein, references to displaying data on the workstations 150 or the visual display 168 regard the process of communicating data across the communication network 166 and processing the data such that the data is viewed on the workstations 150 or the visual display 168, for example, by using a web browser and the like. As is common with web browsing software, the workstation 150 may present sites within the system 200 such that a user can proceed from site to site within the system by selecting a desired link. Alternatively, the visual display 168 may graphically present display screens without user controls that would otherwise enable a person viewing the visual display to make selections for various display options, including to proceed from site to site or display screen to display screen. In other words, various screen displays may be provided in an automatic fashion, such as by cycling through various graphical and textual information without any user input or selections.

Therefore, the experience of each user of the system 200 may be based on the order with which the user progresses through the display screens, or may be automatically provided, for example, by modules that automatically provide various viewing options and display screens. In case graphic controls are made available on the display screens to initiate data processes, convenient navigation options may be provided within the display screens of system 200, including, for example, graphical button controls, tab controls, cursor controls, or the like. Thus, the system may be hierarchical in its arrangement of display screens, or, alternatively, users may be proceed from area to area as a function of selectable graphical screen controls. For that reason, and unless explicitly stated otherwise, the following discussion is not intended to represent any sequential operation steps, but rather to illustrate the components of the system 200.

FIG. 3 is a block diagram illustrating data elements that may be stored in the database 163 and provided in connection with the graphical displays in connection with the present invention. Any device that consumes electricity in a building or other structure may be monitored, such that the energy consumption thereby is stored in the database 163 and is presented on the visual display 168. For example, the energy consumption can be monitored by a suitable smart electric power metering device, or the energy consumed by an entire system or subsystem can be monitored by such device and stored in the database. As noted above, the database 163 may be accessible by and may be stored on the information processor 162. The data stored in the database 163 may be used in connection with generating and displaying the graphical and textual information described herein. As shown in FIG. 3, the data stored in the database 163 originates from diverse sources, including, for example, third party databases that are accessible over the communication network 166 and information stored and provided over the Ethernet link 152. For example, time/location weather conditions information 302, which represents current weather conditions (e.g., precipitation, sky, temperature) for a particular location at a particular time, may be regularly received in the database 163 from one or more third party internet web sites.

Other data stored in the database 163 may be provided in various databases maintained by a proprietor of information processor 162, for example, as provided by the lighting control system 100. For example, lighting information 304 and shade information 306 may be transmitted over the Ethernet link 152 and represent electrical power consumption by and status information of the digital ballast controllers 114 and the shade controllers 136 in a building or other structure. Further, hardwired device information 308, which represents electricity consumption information in connection with one or more hardwired devices, for example, in a building, may be also monitored, transmitted to and stored in the database 163. For example, utility/fire monitoring devices, communication devices (e.g., intercom systems) and other devices that are hardwired in a building may be monitored for electricity consumption and corresponding information is stored in the database 163.

Other devices that consume electricity or other resources may also be monitored and information representing the respective energy consumption of each device may be stored in the database 163. For example and as shown in FIG. 3, the HVAC systems may be monitored and HVAC information 310, which represents electricity consumption and related information directed to heating, ventilation and air conditioning systems, may be stored in the database 163. Moreover, the database 163 may store a 120-volt (“120-V”) plugged devices information 312, which represents electricity consumption of any device that is plugged into an electric outlet, such as a wall socket, and may include, for example, laptop computers, audio devices, computers, fax machines or the like. Careful monitoring of the electrical devices that are plugged into electric outlets is useful for monitoring of amounts of electricity and other energy resources consumed thereby.

In addition to devices that consume electricity, such as lighting loads, motorized window treatments, HVAC, plugged devices, or the like, the database 163 is operable to store other information that affects or otherwise has a bearing on electrical power, energy or resource consumption and savings. For example, water information 314, which represents quantities of water that are consumed and saved in connection with a building or other structure, may be collected and stored in the database 163. Additionally, occupancy status information 316, which represents personnel occupancy of a particular area of a building or other structure, such as a room, atrium, hall, or the like, may be stored in the database 163 and be used to represent energy and resource consumption and savings with respect to the occupancy status. For example, information representing a room that is not occupied and in which lights are, accordingly, automatically switched off is stored in the database 163 and used to represent energy savings. Similarly, information representing lights that are automatically dimmed in response to a measurement by a photosensor is stored in the database 163 and useful for representing energy savings.

Building information 318, which represents respective areas in a building, such as a room, an atrium, hall, or the like, may be stored in the database 163 and used in accordance with the teachings herein. In one embodiment, the building information 318 is useful to provide a floor or other graphical map of a building and, as described in greater detail below, may be selectable by a user to provide information representing a particular room or area of a building or other structure.

FIG. 4 is a block diagram illustrating modules 400 that interact in accordance with the teachings herein to provide graphical screen displays that represent energy and resource consumption and savings. As used herein, the term “module” refers generally to one or more discrete components, including software control components that contribute to the effectiveness of the system 200. Modules can include software elements, including, but not limited to, functions, algorithms, classes and the like. Modules may also include hardware elements, substantially as described and shown herein. Modules can operate independently or, alternatively, depend upon one or more other modules in order to function.

Continuing with reference to FIG. 4, a building location module 402, a device module 404, a time frame module 406 and a power savings module 408 receive data from the database 163 and interact to graphically and dynamically display energy and resource consumption and savings. The respective modules 402, 404, 406 and 408 each rely on additional modules, described below, and operate to provide detailed and context-sensitive information. For example, energy and resource savings and consumption information is provided with regard to a particular building, a particular device and during a particular time-frame. In this way, very detailed and informative data is available for the system 200 to provide to users in intuitive and graphical ways, as shown and described below.

The building location module 402 includes and uses the building information 318 in respective modules directed to a floor module 410, an atrium module 412, a room module 414 and a complete building module 416. The building location module 402 receives and calculates information in connection with the floor module 410, the atrium module 412, the room module 414 and the complete building module 416 to provide energy and resource consumption and savings information for a respective building or area in a building or other structure, for eventual dynamic and graphical display, as described and shown herein.

The device module 404 includes and uses device information stored in the database 163 in connection with a plurality of modules that receive and use information stored in the database. For example and as shown in FIG. 4, a lighting module 418, which receives and uses the lighting information 304, calculates energy consumption and savings in connection with one or more lights. An HVAC module 420, which receives and uses the HVAC information 310, calculates energy consumption and savings in connection with heating, ventilation and air conditioning. A plug-ins module 422, which receives and uses the 120-V plugged device information 312, calculates energy consumption and savings in connection with one or more devices connected to an electrical outlet. Further, a water module 424, which receives and uses the water information 314, calculates consumption and savings in connection with water.

Continuing with reference to FIG. 4, a time frame module 406 includes and uses time frame information stored in the database 163 to provide analysis options with regard to specific time periods. For example, a day module 426, a week module 428, a month module 430 and a year module 432 represent energy and resource savings and consumption over a twenty-four hour period of time, a week period of time, a month period of time or a year period of time, respectively.

A power savings module 408 includes and uses electricity and other resource information stored in the database 163 in order to provide resource and power consumption and savings information. An electricity module 434, for example, receives and uses the lighting information 304, the shade information 306, the hardwired device information 308, the HVAC information 310 and the plug-in device information 312 to provide electricity consumption and savings information. A carbon dioxide (CO₂) module 436 calculates savings in terms of carbon dioxide emissions (in pounds) in response to the electricity savings information of the electricity module 434. A fuel module 438 determines savings in terms of the consumption of fuel, such as, for example, gasoline (measured in gallons) or coal (measured in pounds) in response to the electricity savings information. A financial savings module 440 calculates the resulting savings in financial costs (e.g., measured in dollars) associated with power savings module 408. Accordingly, the amount of CO₂ not emitted, the amount of fuel not consumed and the amount of money saved are calculated using equations based upon measured ratings of electricity and other resources.

The following numerical assumptions and arithmetic formulas may be used to calculate equivalent savings. A user of the system 200 is able to provide the electricity rate R_{ELEC}, i.e., the cost of 1 kWh of electricity, e.g., approximately $0.10 per kWh. Therefore, the amount of money saved during a time period can be determined by multiplying the amount of electricity saved in the time period by the electricity rate R_{ELEC}, i.e.,

Money saved(in $)=R_{ELEC}*electricity saved(in kWh). (Equation 1)

To determine the amount of carbon dioxide (CO₂) not emitted during a time period, the estimation that, for example, approximately 1.91 pounds of carbon dioxide is produced during the generation of 1 kWh of electricity (assuming coal fired generation), is used, i.e.,

CO₂ not emitted(in lbs)=1.91*electricity saved(in kWh). (Equation 2)

Further, the estimation, for example, approximately 1 pound of coal is burned to generate 1 kWh of electricity is used to estimate the pounds of coal not burned due to the amount of electricity saved during a time period, i.e.,

Coal not burned(in lbs)=electricity saved(in kWh). (Equation 3)

Alternatively, the estimation that 1 kWh of electricity is generated by burning approximately 0.0275 gallons of gasoline is used to estimate the gallons of gasoline that are not used as a result of the amount of electricity saved during a time period, i.e.,

Gasoline saved(in gal)=0.0275*electricity saved(in kWh), (Equation 4)

since 1 kWh=3,600,000 electric Joules and the energy in one gallon of gasoline produces approximately 132*10⁶ thermal Joules.

Further, cumulative energy savings, for example, by fossil fuel power plants can also be provided. The results of such calculations that represent, for example, CO₂, gasoline and financial savings may be dynamically and intuitively displayed for users, thereby providing a useful and helpful way to recognize the effectiveness of various environmental savings or otherwise “green” measures that a building or other structure implements.

As noted above, the visual display 168 provides a graphical and dynamic display of energy and resource consumption and savings. For example, a graphical display of electricity consumption is provided as a function of a user interface that is displayed on the visual display 168. In another aspect of the invention, graphical (and textual) displays of energy and resource consumption and savings can be provided according to the teachings herein on many other devices, including, for example, PDA's and telephones.

FIGS. 5A-5D represent an example of a display screen 500 that is provided to users of the system 200 over time in accordance with a first embodiment of the present invention. As shown in FIGS. 5A-5D, the display screen 500 includes various components that are extremely intuitive, and provide detailed information that is easily viewed and understood without requiring more than a brief glance from the viewer. The data that is represented on the display screen 500 is retrieved from the database 163 (FIG. 3) and in accordance with the modules 402-440 (of FIG. 4).

The display screen 500 includes a historical energy savings display portion 500A and an instantaneous energy savings display portion 500B. On the historical energy saving display portion 500A, the amount of lighting energy saved is shown in comparison to a reference value of energy (calculated as described below) across various time periods and displayed in a graphical plot 502. Specifically, in FIG. 5A, the historical energy savings (in kWh) is displayed for the last three hours with individual “bars” 504 representing the average energy savings over 15-minute periods. A plurality of time period identification tabs 506 are arranged below the graphical plot 502. One of the tabs 506 is highlighted to identify which of the time periods across which the graphical plot 502 is displaying the energy savings. For example, in FIG. 5A, the first tab 506 labeled “3 Hours” is highlighted and the three-hour time period from 2 p.m. to 5 p.m. is displayed on the graphical plot 506.

An energy savings list 508 is provided next to the graphical plot 502. The energy savings list 508 displays the average amount of lighting energy saved (in kWh), the amount of money saved (in dollars), the amount of coal not burned (in lbs), and the amount of CO₂ not emitted (in lbs) over the specific time period.

The instantaneous energy savings display portion 500B provides a simple bar graph 510 the height of which is representative of the instantaneous lighting energy savings. By simply glancing at the instantaneous energy savings display portion 500B of the display screen 500, a user can quickly determine, for example, that 55% of electricity savings is presently occurring, which represents significant savings in terms of money, greenhouse gas pollution and fossil fuel consumption.

The graphical plot 502 can alternatively display the amount of lighting energy savings over the last day (i.e., the last 24 hours) as shown in FIG. 5B, over the last week (i.e., the last 7 days) as shown in FIG. 5C, over the last month (i.e., the last 30 days) as shown in FIG. 5D, and over the last year as shown in FIG. 5E. Further, the graphical plot 502 can display the amount of lighting energy savings since the system 200 was first commissioned (i.e., from the start) as shown in FIG. 5F. The data provided in the energy savings list 508 changes as the time period of the graphical plot 502 changes.

Further, the display screen 500 includes a building title 520 and a room title 522 informing the user of the visual display 168 for which room the energy savings are displayed on the historical energy savings display portion 500A and the instantaneous energy savings display portion 500B. A time and date portion 524 displays the present time and date for the user, while a location and weather portion 526 displays the city and state where the building is located

According to the first embodiment of the present invention, the display screen 500 of the visual display 168 automatically changes as time progresses to automatically display different information for a user. For example, the display screen 500 could automatically change between the screens shown in FIGS. 5A-5F to consecutively show the energy savings for the different time periods.

Alternatively, the visual display 168 could be provided with a touch screen or other inputs means, such as a keyboard or mouse, such that the user is able to adjust the information that is displayed on the display screen 500. For example, the user could select one of the time period identification tabs 506 to select a different time period to be displayed on the graphical plot 502. Also, the user could click on the room title 522 to display a room title list 523 and select another room for which to display the energy savings as shown in FIG. 5G. Further, the user could select an information tab 528, such that the visual display 168 will present an information display screen (not shown) containing additional information about the building.

The user is also able to select a compare tab 530 in order to display a comparison display screen 550, for example, as shown in FIG. 5H. The instantaneous energy savings display portion 500B is not present on the comparison display screen 550. However, the comparison display screen 550 exhibits multiple energy savings lists 552, 554, 556 that contain energy savings data for different time periods, such that the user is able to compare the past and present operation and energy savings of the building. For example, as shown in FIG. 5H, the first energy savings list 552 shows the energy savings for the present week (i.e., the last seven days or “this week”), the second energy savings list 554 shows the energy savings for the week before the present week (i.e., one week ago or “last week”), and the third energy savings list 556 shows the energy savings for a week one year ago (i.e., “this week last year”). The graphical plot 502 displays a first line plot 502A of the lighting energy savings of the present week and a second line plot 502B of the energy savings of the week before the present week.

In prior application Ser. No. 12/044,672, filed Mar. 7, 2008, described above, the reference level used to calculate energy savings is derived by calculating the maximum energy consumed by the energy consuming devices in the system or subsystem, assuming all devices are on all the time at maximum power level. For example, in a lighting system, it would be assumed that all lights would be on all the time at maximum brightness. This maximum energy consumed level is reflected in the “maximum savings” reference level in the display shown in that prior application. That is, the maximum potential savings would be calculated as the difference between the maximum energy usage assuming all devices were on all the time at maximum levels and the minimum energy usage that would result assuming that all such devices were turned off. This would result in maximum savings (i.e., zero usage).

As discussed above, this may be useful, but it may not always be realistic, since the widespread use of automatic controls and operator usage and seasonal trends may result in a more realistic lower reference level than this maximum reference level. This is because rarely, if ever, are all of the energy consuming devices turned on to maximum levels all the time. For example, daylighting controls, occupancy sensors, time of year, dimmer controls, etc. may result in a lower, and possibly variable reference level from which to calculate savings. The present invention provides an improvement over the method described in the prior application to calculate savings information.

In the prior application Ser. No. 12/044,672 described above, the reference value against which the savings are determined is the maximum usage value possible, that is, when all the devices drawing electrical current in a subsystem are turned on all the time at maximum levels. For example, if it is a lighting system of a building that is being monitored for savings, the reference would be determined by all lamps being turned on at maximum and operating for 24 hours a day seven days a week.

Although this is a useful way of determining savings, it may be more practical and more useful in certain situations to use a different and possibly variable reference, for example, according to the invention, a peak power level as determined by an electrical power meter. For example, a peak power level during a certain time period could be used as the reference value to determine the savings. Thus, the peak power level in, say, a certain time period, for example, a week, or a month, or a shorter or longer period of time, could be determined by reading the measurement from an electrical power usage meter, for example, a smart meter that provides digital data concerning instantaneous usage. The peak value during a certain time period or window could be determined and that value stored. An actual usage value is then compared to that peak value to determine the savings.

This is shown in FIG. 2A, which shows a smart meter 1200 that provides metered power to the lighting system 100. The smart meter 1200 also provides usage data to the network 166 for processing by the information processor 162 and storage in the database 163 and for display on the display device 168 and the workstations 150.

FIG. 12 shows, for example, the output of a power usage meter 1200 during an exemplary time period of one year. A time window W can be set as indicated. During this time window, for example, two peaks are noted at A and B. There is also a third peak during the time window because the usage is rising when the window ends at C. Various methods can be employed to determine the savings based on the meter data.

According to one method, a single maximum peak during the time period is determined. In the example shown, that could be the peak A. This peak value is stored and used as a reference value for the window period W. Thus, the power savings at any instant in time would comprise the difference between the peak power A and the instantaneous value of the power usage. Energy savings can be calculated for a given period of time as the difference between the actual energy usage during that time and the stored reference peak value. The actual energy usage may be calculated based on the estimated usage for the consuming devices (based on the lighting system information 304, such as, for example, dimming levels, whether lights are on or off) or by resort to the actual instantaneous power usage from the electrical power meter 1200. In either case, the energy usage shown is calculated for the time period 506 selected (not to be confused with the window W) and displayed at 500A.

According to another method, an average of the peaks during the time window could be employed. Thus, with three peaks A, B and C, as shown in FIG. 12, the peaks can be averaged as (A+B+C)/3 to provide a reference against which actual usage is compared to determine the savings. Alternatively, a median average or some other average could be employed.

Alternatively, instead of determining a usage peak or peaks, a full average of the usage during the time window W can be employed as the reference to determine savings.

In any instance where the usage exceeds the reference, for example, where usage exceeds the average, or a new peak has been measured, the savings would be negative and could be displayed as such.

In order to account for this, however, instead of having a fixed window W, the system of the invention can employ a rolling time window which shifts continuously or incrementally, for example, each hour or day or monthly, or at any other interval, thereby including within the window W new peaks that have occurred, which can then be used as a new peak, or to calculate a new average. The display would thus change the reference indication, i.e., the maximum savings reference value, based upon the newly determined peak or peaks, or average and savings would be determined based upon the new reference. This is particularly useful if, for example, the user of electrical power is subject to seasonal demands, for example, higher lighting costs in the winter season and lower lighting costs in the summer, higher HVAC costs in the summer versus winter, etc. Thus, the savings will more realistically reflect the savings expected during that season.

Another alternative window technique is to start with the peak in a given window W for the first window period, and thereafter, as the window moves, to use an average of the peaks determined in each new window.

The window W can also be user defined, i.e., any time duration as desired by the user, for example, hourly, daily, weekly, monthly, or any desired duration, for example, based upon a seasonal duration. The window time period can be selected by selecting the window button 529 shown in FIGS. 5A-5H which will display a drop-down menu giving the user various options for the window duration.

It is also possible to dispense with any window at all and simply use the highest peak that has been measured as the reference value. Thus, the highest value obtained is always stored and used as the reference value, with no limit on the duration or the time over which the peak is measured.

The reference value against which savings are determined can also be set by the user, for example, the user can select a particular instant in time and use the value of the power usage at that instant. Alternatively, the user may select or specify an arbitrary value to be used as the reference value.

According to the invention, the peaks are recorded in the database 163. These peaks can be used for reporting purposes, for example, determination of seasonal peaks, energy usage trends, etc., which can allow for improvements in reduction of energy usage.

Returning to FIGS. 5A to 5H, these figures show the “Reference” level from which the energy savings were determined assuming a time window W (FIG. 12) of two months.

Thus, in FIG. 5A, the “Reference” level does not change because graph 500A shows savings over a three-hour interval, and the “Reference” level, determined for a two-month window, has not changed during the three-hour period.

FIG. 5B shows savings for a 24-hour interval, and the reference determined during the two-month window W also has not changed during the 24-hour interval.

Similarly, in the example shown in FIG. 5C, the “Reference” level has not changed.

In FIG. 5D, it is assumed the Reference level, determined from the peak usage during the two-month window, has changed during the 30-day interval displayed. This is reflected in the change in the reference level. As shown, the reference has changed (it has increased during the 30-day interval) and the savings have accordingly been reduced.

In FIG. 5E, the energy savings are shown over a year (based on the power usage meter graph shown in FIG. 12), and the reference has been shown (based on using the peak average in a rolling two-month time window).

Similarly, FIG. 5F shows the savings for a time period since initialization of the monitoring system of the invention, and the reference level is determined using a rolling two-month window.

FIG. 6 is a simplified flowchart of a configuration procedure 600 that is executed during the initial configuration of the system 200, for example, by one of the workstations 150. First, the user is prompted at step 610 to set the window W (button 529) which will be used to determine the reference level. The user is then presented at 612 with options for determining the reference energy savings level, for example, the single maximum peak during the window W, the average of the peaks during the window W, or the full average as discussed above (or some other algorithm).

Next the system obtains the data from the meter to calculate the reference level at 614 based on the algorithm selected at step 612. The user is then prompted for the electricity rate R_{ELEC} set by the electricity company providing service to the building at step 622. After the user enters the electricity rate R_{ELEC}, the electricity rate R_{ELEC} is stored in the database 163 at step 624 and the procedure 600 exits.

FIG. 7 is a simplified flowchart of a display procedure 700 for displaying the display screen 500 according to the first embodiment of the present invention. The display procedure 700 is executed periodically, for example, by the information processor 162 every 10 seconds to update the information shown on the visual display 168 either automatically or manually (i.e., in response to a user input). At step 710, the time and date of the time and date portion 524, and the weather information of the location and weather portion 526 are updated on the display screen 500. The information processor 162 retrieves the total instantaneous energy consumption from the database 163 at step 712, and calculates the total electrical energy savings at step 714 (e.g., by subtracting the total instantaneous energy consumption from the reference energy consumption level determined in the configuration procedure 600 of FIG. 6). Next, the instantaneous energy savings display portion 500B of the display screen 500 is updated at step 716. At step 718, the information processor 162 calculates the various energy savings quantities of the energy savings list 508, (e.g., using Equations 1-3 and taking into account the time period that is displayed on the graphical plot 502), before the data of the energy savings list 508 is updated at step 720. Additionally, the average power savings may be calculated, for example, by subtracting the average power consumed over the past hour from the reference energy consumption level.

The information of the historical energy savings display portion 500A of the display screen 500 (i.e., the graphical plot 502) is periodically updated at a rate dependent upon the time period that is presently being displayed on the graphical plot. For example, if the graphical plot 502 is displaying three (3) hours of time, the graphical plot may be updated every 15 minutes. Alternatively, if the graphical plot 502 is displaying twenty-four (24) hours of time or a greater time period, the graphical plot may be updated every hour. Referring back to FIG. 7, if the graphical plot 502 should presently be updated at step 722, the historical energy savings portion 500A of the display screen 500 is updated at step 724.

If the time period displayed on the graphical display 502 should be automatically adjusted at step 726, the information processor 162 changes the display screen 500 to show the next time period at step 728, updates the energy savings list 508 on the display screen 500 at step 730, and updates the historical energy savings portion 500A on the display screen 500 at step 732, before the procedure 700 exits.

FIG. 8 is a simplified flowchart of an input procedure 800 executed by the information processor 162 in response to a selection at step 810 of one of the time period tabs 506, the room title list 523, the information tab 528, or the compare tab 530 of the display screen 500. If one of the time period tabs 506 is selected at step 812, the information processor 162 changes the display screen 500 to show the appropriate time period at step 814, updates the energy savings list 508 on the display screen 500 at step 816, and updates the historical energy savings portion 500A on the display screen 500 at step 818. If the room title list 523 is selected at step 820, the information processor 162 updates the information shown on the visual display 168 to that of the selected room at step 822 and the procedure 800 exits. If the information tab 526 is selected at step 824, the information screen is displayed on the visual display 168 at step 826, before the procedure 800 exits. If the compare tab 530 is selected at step 828, the comparison screen (shown in FIG. 5H) is displayed on the visual display 168 at step 830, and the procedure 800 exits.

FIG. 9A illustrates an example of an energy resource consumption and savings graphical gauge 900 according to a second embodiment of the present invention. In the example shown in FIG. 9A, the gauge 900 includes a dial graph that includes two respective regions: an energy-saved region 902 and an energy-used region 904, which are separated by a line or a needle 906. The needle 906 points to a location on the gauge 900 that represents the instantaneous value at which energy is being consumed. In the example gauge 900 illustrated in FIG. 9A, the power consumption is measured at 46%, and the power savings is measured at 54%. In this way, a single gauge visually displays both savings and consumption. Further, the energy savings portion of the gauge 900 may be colored, for example, green (which is representative of an association of good environmental practice and resource consumption), while energy consumption portion of the gauge may be another color, for example, blue. Other color combinations can be used, or can be selected by the user. As in the first embodiment of the present invention, the data that is represented in the gauge 900 is determined from the database 163 and in accordance with the modules 402-440. In other words, the back-end data source to the gauge 900 includes the database 163 and the modules 402-440.

Alternative embodiments of the gauge 900 are envisioned herein. For example, instead of values on the gauge 900 representing percentages (i.e., 1%-100%), numeric values representing kilowatts of electricity may be provided. In yet another alternative embodiment, the gauge may represent both kilowatts and percentages. In yet another alternative, various “skins,” as known in the art, may be applied to provide the gauge 900 in various ways. For example, digital-looking numeric values may be provided instead of an “analog” appearing gauge (such as the example shown in FIG. 9A). Alternatively, the gauge 900 may be provided as a line graph, a bar graph or other graphical format other than a dial graph. Furthermore, audio features may be provided, such that when, for example, needle 906 reaches a particular level, an audible tone is emitted.

The gauge 900 may respond when energy consumption or savings peaks to a predetermined or predefined level. For example, needle 906 may read 98% of electricity consumption during a peak electricity consumption period, effectively positioning the needle practically straight down. Once this (or another) predefined level is reached, gauge 900 may automatically adjust the range of display. In other words, the value 98% consumption may automatically be repositioned in the dial so that the needle no longer points down. Further, the scale of the graph may be adjusted, such that that range exceeds, for example, 100%. In the revised scale, the high end may read 120%. By dynamically and automatically revising the high end (or, alternatively, the low end) of the range of values provided in gauge 900, the needle 906 may be repositioned along the dial accordingly. This feature provides various benefits, such as enabling a representation of energy consumption that exceeds a predefined range. Further, by automatically and dynamically adjusting the range of gauge 900, the position needle 906 correspondingly adjusted and energy consumption (or savings) can appear more or less effectively, as desired.

FIG. 9B illustrates an example of an energy resource consumption and savings graphical gauge 950 when the energy consumption has exceeded the maximum rated output of the facility. As shown in FIG. 9B, the needle 906 points to a power consumption on the gauge 950 that is in excess of 100%, e.g., at 107%. The portion of the gauge 950 above 100% is a different color than the rest of the gauge, e.g., colored red to represent a warning. Further, the gauge has been automatically and dynamically rescaled to range between 0% and 120%.

FIGS. 10A-10D show an example of a display screen 1000 that is provided on the visual display 168 to users of the system 200 according to the second embodiment of the present invention. On the display screen 1000 shown in FIGS. 10A-10D, information is graphically displayed for electricity consumption and savings over time and at a particular location and with respect to particular areas of a building. As with the first embodiment, the data that is represented on the display screen 1000 is retrieved from the database 163 in accordance with the modules 402-440.

In particular, the display screen 1000 is vertically bisected into two halves: a historical energy savings display portion 1000B on the right-hand side and an instantaneous energy savings display portion 1000A on the left-hand side. The instantaneous energy savings display portion 1000A represents energy consumption and savings at the current time, while the historical energy savings display portion 1000B represents an historical and location-specific representation of energy consumption and savings.

With reference now to the left-hand side of the display screen 1000 (i.e., the instantaneous energy savings display portion 1000A), a location indicator 1002 is provided to indicate a particular building location to which display screen 1000 is referring. An electrical power table 1004 provides a textual display formatted in a table of electrical power consumption and savings. As shown in FIGS. 10A-10D, the table 1004 includes two rows, where the top row represents a reference consumption of electricity without any energy conservation. Since the top row always represents 100% of the reference consumption, the savings value is always 0%. The bottom row represents the amount of actual instantaneous electrical power presently being consumed and saved. In the examples shown in FIGS. 10A-10D, the reference electrical power consumption is 25 kilowatts (as shown in the top row of table 1004). The actual amount of instantaneous electrical power consumption is 12.2 kilowatts, or 46% of the maximum, and the amount of electrical power savings is 12.8 kilowatts, or 54%. The reference window W (FIG. 12) is selected via button 1029.

A gauge section 1006 on the display screen 1000 includes the gauge 900 (i.e., as shown FIG. 9A) and represents the instantaneous percentage of electrical power that is consumed. As described above with reference to FIG. 9A, the gauge 900 provides a simple and graphical representation of the amount of energy saved and consumed. An equivalent savings table 1008 represents equivalent savings by the reduced and actual electrical power consumption, in terms of money ($), of carbon dioxide emissions measured in pounds (CO₂ lbs.), and of gasoline measured in gallons. The table 1008 includes a top row that displays the equivalent savings of money, CO₂ emissions and gasoline over the most recent twenty-four hours, and a bottom row that displays the equivalent savings of money, CO₂ emissions and gasoline cumulatively. Thus, by merely glancing at the instantaneous energy savings display portion 1000A on the left-hand half of the display screen 1000, a user can quickly determine that the present electricity savings of 54% is resulting in significant savings in terms of money, greenhouse gas pollution and fossil fuel consumption.

Referring now to the historical energy savings display portion 1000B on the right-hand side of the display screen 1000, the historical representation of electrical power consumption and savings is displayed for lighting power consumed over various time periods. A location navigation section 1010 is provided to enable a user to select respective locations within a building, such as a floor, an atrium, or a room, in order to view resource (e.g., electrical power) consumption and savings therefor. In the example shown on the display screen 1000, navigation arrows are provided in the location navigation section 1010 that, when selected, cause the views within the display screen to change to represent respective areas within a building or other structure. A time and date section 1011 displays the current time and date for the viewer.

A graphical display section 1012 displays an area graph that represents lighting power consumption and savings over various periods of time. The example area graph provided in the graphical display section 1012 is formatted similarly as the gauge 900 in that power consumption values and savings values are simultaneously displayed and may be represented by different colors. For example, energy savings may be colored in green. Of course, other types of graphs may be provided in the graphical display section 1012, such as line graphs, bar graphs, pie graphs or the like. Furthermore, graphical screen controls may be provided for a user to select different graph types and layouts according to the personal preference if a user.

Further, a time period selection section 1014 includes selectable tabs for selecting various time periods that may be represented and displayed in the graph provided in the graphical display section 1012. For example, a user may select a twenty-four hour period, a seven-day period, a one-month period or a one-year period of time in the time period selection section 1014 and immediately review the corresponding details of energy or resource consumption and savings during the respective period of time. As shown in FIG. 10A, the amount of lighting power consumed and saved over the last twenty-four hours of time is displayed. Alternatively, the display section 1012 of FIG. 10B displays the amount of lighting power consumed and saved over a seven-day period of time. The graphical display section 1012 of FIG. 10C displays amount of lighting power consumed and saved over a one-month period of time, while the graphical display section 1012 of FIG. 10D displays amount of lighting power consumed and saved over one year. In each of the area graphs displayed in the graphical display section 1012 in FIGS. 10A-10D, the Y-Axis range represents electrical energy in kWh, i.e., 0-30 kWh. The X-Axis represents time and varies depending upon the selected time frame in the time frame selection section 1014.

FIG. 10B illustrates the example display screen 1000 with a seven-day time period selected in the time frame selection section 1014. The area graph in the graphical display section 1012 in FIG. 10B indicates the fluctuations of lighting power consumption and savings during and between each day of the week. Alternatively, FIG. 10C illustrates the example display screen 1000 with a one-month time period selected in the time frame selection section 1014. The area graph in the graphical display section 1012 in FIG. 10C indicates the fluctuations of lighting power consumption and savings in a respective day of the month, and graphically represents decreased levels of lighting power consumption during weekends. Furthermore, the area graph in the graphical display section 1012 in FIG. 10D indicates the fluctuations of lighting power consumption and savings during months of the year, and graphically represents decreased levels of lighting power consumption during the summer months, when, for example, daylight hours are longer than in the winter months and, accordingly, greater savings are realized by reducing lighting power during the summer months.

Continuing now with reference to FIGS. 10A-10D, a location and weather section 1016 is displayed to provide the viewer with a convenient summary of weather conditions for a particular area. A home navigation section 1018 is provided to enable a user to return to a default display screen configuration by simply selecting the home button. For example, the user may select controls and options within the display screen 1000 in order to modify views representing time periods, devices, and locations, and may, thereafter, desire to be presented with the original display, e.g., total electrical power consumed over twenty-four hours for the entire building, by use of a single graphical control selection (i.e., by selecting “Home”). In an alternative embodiment, a default “home” screen is automatically provided after a predefined period of time, such as a time-out variable, as known in the art. A selectable control (i.e., “Info”) in the home navigation section 1018 causes the display screen 1000 to provide additional information (not shown), for example, regarding electrical power savings, the various benefits of energy conservation provided by a respective building or location, or the like.

FIG. 11 shows a display screen 1100 according to a third embodiment of the present invention. The display screen 1100 includes additional graphical screen controls in a device selection section 1113 in accordance with a preferred embodiment. Selectable device options are provided in the device selection section 1113 for a user to select plug-in devices, HVAC, lighting and the total combination thereof. In the example shown in FIG. 11, the twenty-four hour period of time is selected in the time selection section 1014 and the total electrical power is selected in the device selection section 1113, thereby representing the total electrical power consumed and saved in the building over the past day.

Accordingly, the display screens 500, 1000, 1100 provide intuitive and useful information representing energy and resource consumption and savings over time and in respective locations. Although many of the descriptions and examples provided herein refer to graphical screen controls that are selectable by a user to display various features in the display screens 500, 1000, 1100, the invention is not so limited. It is envisioned, however, the visual display 168 comprises a large display screen, such that viewers in a large open space can view the display screens 500, 1000, 1100 showing respective energy consumption and savings for a particular building or other structure.

Note that the values that are provided on the display screens 500, 1000, 1100 in FIGS. 5A-5H, 10A-10D, and 11 are provided as examples only and may not be consistent with the preferred equations to calculate these values, for example, as shown in Equations 1-4.

The embodiments of the present invention are now further described with reference to some hypothetical examples. A person is traveling from New York to California by air. The person arrives at the airport two hours before his scheduled flight and is waiting in the terminal from where his plane is scheduled to depart. The display screen 500 is provided in the visual display 168 and electrical power consumption and savings in various areas of the airport over various periods of time are graphically and textually displayed for the general public. The traveler enjoys watching the many indications of energy, cost and pollution savings provided in the airport.

In another example, a display screen 168 is provided in the lobby of a commercial office building where a person works on a daily basis. Display screen 500 is regularly shown on visual display 168, and the various locations of the office building are represented with regard to electrical power consumption and savings. The person regularly recognizes that the respective floor on which he works is typically represented as using more electricity than other floors of the office building. After watching the display screen 500 cycle through the various devices that consumed electrical power, the person realizes that much of the electricity is consumed during lunch hours and by plug-in devices and lighting. Accordingly, the person encourages his office mates to switch off lights during lunch and to switch off plugged-in electrical devices. Over time, the total amount of electricity consumed on the person's floor decreases, resulting in a significant savings.

Thus, the visual display 168 disclosed herein provides a useful way for energy and resource conservation to occur by representing savings and consumption in intuitive and informative ways. By providing particular building location navigation options, users can identify particular areas of savings and excessive consumption of electricity in the building. Historical perspectives are conveniently provided for viewers to identify when periods of high and low consumption of electricity and other resource occurs. Moreover, the visual display 168 provides a useful way to identify particular devices, such as plug-in devices, lighting, HVAC, and hardwired devices that consume electrical power either excessively or efficiently. Moreover, a unique and dynamically rotating gauge that represents electrical power consumption and savings may be provided on the visual display 168. The visual display 168 provides information that represents environmental and fiscal savings, as well as displaying returns on investment in real-time, over historical time and in calculable terms. Moreover, the visual display 168 allows users to control displays and selections representing various locations, which further provides information directed to costs and environmental savings and benefits.

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A system for displaying an electronic representation of the consumption of electrical energy by an electrical energy consumer in a graphical format, the system comprising:
an information processor coupled to a communication network;
a database accessible by the information processor that stores information including a reference amount of the electrical energy capable of being consumed by the consumer and the actual amount of the electrical energy consumed by the consumer;
the reference amount being obtained from an electrical power usage meter through which electrical energy is supplied to the consumer;
the information processor operable to determine an amount of electrical energy saved as the difference between the reference amount of the electrical energy capable of being consumed by the consumer and the actual amount of the electrical energy consumed by the consumer;
wherein the reference amount is determined either from a peak amount of power consumed by the consumer during a preset window of time during which the consumer utilizes electrical energy or by an average amount of power consumed by the consumer during the preset window of time; and
a visual display operable by the information processor, the visual display providing an electronic representation of the amount of the electrical energy consumed by the consumer and the amount of the electrical energy saved, wherein the visual display presents the electronic representation in a graphical format.

2. The system of claim 1, wherein the reference amount is determined from a single power usage peak during the time window.

3. The system of claim 2, wherein the reference amount is determined from an average of a plurality of power usage peaks during the time window.

4. The system of claim 1, wherein the reference amount is determined from an average power usage during the time window.

5. The system of claim 1, wherein the time window is user set.

6. The system of claim 1, wherein the time window is a rolling window.

7. The system of claim 6, wherein the time window is a continuous rolling window.

8. The system of claim 6, wherein the reference amount is determined as a peak in a first time window, and peaks in subsequent time windows are averaged with peaks in preceding time windows.

9. The system of claim 1, wherein the window comprises a time period from initialization of the system to the current time.

10. The system of claim 1, wherein the reference amount is user set.

11. The system of claim 1, wherein the time window comprises any of an hour, day, week, month, season, year or any user set time duration.

12. The system of claim 1, wherein the actual amount of electrical energy consumed by the consumer is determined by usage information provided by the electrical power usage meter.

13. The system of claim 1, wherein the actual amount of electrical energy consumed by the consumer is determined by electronic device information stored in the database.

14. The system of claim 1, wherein the graphical format of the electronic representation is a graph formatted with a range of values and an indicator of an indicated value in the range, wherein the indicated value represents the consumption and the savings of the electrical energy by the consumer.

15. The system of claim 14, wherein the graph includes an electrical energy-used portion and an electrical energy-saved portion, the combination of the electrical energy-used portion and the electrical energy-saved portion representative of an amount of the electrical energy equal to the reference amount.

16. The system of claim 15, wherein the electrical energy-saved portion is colored green.

17. The system of claim 14, wherein the range represents percentages of the electrical energy, and has a minimum range value of approximately 0% and a maximum range value of 100% representative of the reference amount of the electrical energy.

18. The system of claim 17, wherein the range of values dynamically changes when the amount of the electrical energy consumed by the consumer exceeds the reference amount of the electrical energy.

19. The system of claim 18, wherein the range of values dynamically changes by increasing the maximum range value above 100%.

20. The system of claim 19, wherein the range on the graph is automatically rescaled between the minimum range value and a new maximum range value above 100%.

21. The system of claim 20, wherein the graph is a gauge formatted with a dial having a range of values and a needle that points to the indicated value in the range.

22. The system of claim 1, further comprising electronic location information stored in the database that represents at least one location where the consumer consumes electrical energy, wherein the visual display provides the electronic representation of the electrical energy and the consumption of the electrical energy as a function of the at least one location represented by the electronic location information.

23. The system of claim 1, further comprising electronic time period information stored in the database that represents a period of time when the consumer consumes the electrical energy, wherein the visual display provides the electronic representation of the electrical energy and the consumption of the electrical energy as a function of the period of time represented by the electronic time period information.

24. The system of claim 23, wherein the electronic time period information represents a plurality of time periods when the consumer consumes electrical energy, and the visual display presents the electronic representation as a function of the plurality of time periods.

25. The system of claim 13, wherein the electronic device information represents a plurality of respective devices that consume electrical energy, and the visual display presents the electronic representation as a function of the plurality of respective devices.

26. The system of claim 25, wherein the plurality of respective devices includes lighting equipment, HVAC equipment, plug-in equipment and hard-wired equipment.

27. The system of claim 1, further comprising electronic equivalent savings information representing at least one other resource-saved as a function of the savings of the electrical energy, wherein the visual display presents the electronic equivalent savings information.

28. The system of claim 1, further comprising electronic emissions information representing an amount of carbon dioxide that is released into the atmosphere as a function of the at least one device using the electrical energy.

29. The system of claim 1, further comprising electronic emissions savings information representing an amount of carbon dioxide that is not released into the atmosphere as a function of the electronic electrical energy savings information, wherein the visual display presents a representation of the electronic emissions savings information.

30. The system of claim 1, wherein information representing the actual amount of the electrical energy-used by the consumer is received over a digital ballast communication link.

31. The system of claim 1, wherein the savings of the electrical energy occurs as a result of dimming lights, switching off lights and using daylight.

32. The system of claim 1, further comprising electronic electrical energy savings information stored in the database that represents the difference between the rated amount of the electrical energy capable of being used by the consumer and the actual amount of the electrical energy-used by the consumer.

33. The system of claim 1, wherein the database comprises electronic device information concerning electrical energy consuming devices of the consumer from which the actual electrical energy usage by the consumer can be determined.

34. The system of claim 33, wherein the electronic device information comprises the maximum rated power consumption of each device, the dimming level of each device and whether each device is on or off.

35. The system of claim 1, wherein the actual amount of the electrical energy consumed by the consumer is determined by obtaining instantaneous values of power usage from the electrical power usage meter.
